(19) United States
(12) Patent Application Publication
(10) Pub. No.: US 2025/0300781 A1
(43) Pub. Date: Sep. 25, 2025

(54) PHASE TRACKING REFERENCE SIGNAL FOR SIMULTANEOUS MULTI-PANEL UL TRANSMISSION

(71) Applicant: LENOVO (BEIJING) LIMITED, Beijing (CN)

(72) Inventors: Bingchao Liu, Beijing (CN); Chenxi Zhu, Fairfax, VA (US); Lingling Xiao, Beijing (CN); Wei Ling, Beijing (CN); Yi Zhang, Beijing (CN)

(21) Appl. No.: 18/844,481

(22) PCT Filed: Apr. 29, 2022
(86) PCT No.: PCT/CN2022/090481

§ 371 Date: Sep. 6, 2024

(51) Int. Cl. H04L 5/00; H04B 7/0456; H04W 72/21

(52) U.S. Cl. CPC H04L 5/0051; H04B 7/0456; H04W 72/21

(57) ABSTRACT

Methods and apparatuses for PT-RS enhancement are disclosed. In one embodiment, a UE comprises a transceiver; and a processor coupled to the transceiver, wherein the processor is configured to receive, via the transceiver, a configuration to transmit 2 or 4 PT-RS ports when 4 antenna ports codebook based PUSCH transmission is configured; and determine the mapping between PUSCH antenna ports and the PT-RS ports.

### FIELD

The subject matter disclosed herein generally relates to wireless communications, and more particularly relates to methods and apparatuses for PT-RS enhancement.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Downlink Control Information (DCI), Space Division Multiplex (SDM), Physical Uplink Shared Channel (PUSCH), Transmission Configuration Indicator (TCI), FR2 (frequency range 2: 24250 MHz-52600 MHz), Phase Tracking Reference Signal (PT-RS), Demodulation Reference Signal (DMRS), Spatial Division Multiplex (SDM), Frequency Division Multiplex (FDM), Sounding Reference Signal (SRS), transmission reception point (TRP), Bandwidth part (BWP), codebook (CB), non-codebook (nCB), Physical Resource Block (PRB), Code Division Multiplex (CDM), SRS resource indicator (SRI), Transmit Precoding Matrix Indicator (TPMI), Most Significant Bit (MSB), Least Significant Bit (LSB), resource element (RE), Channel State Information Reference Signal (CSI-RS).

One typical development for simultaneous multi-panel UL transmission is single-DCI based SDM multi-panel PUSCH transmission, where different PUSCH layers scheduled by a single DCI are transmitted by different panels (e.g. two panels) by using different UL TCI states (e.g. two UL TCI states). In this type of UL transmission, the PUSCH layers transmitted by two panels are on the same time-frequency resources. So, additional PT-RS ports are required for phase noise estimation for different panels in FR2. In addition, the association between different PT-RS ports and the PUSCH ports, and the association between different PT-RS ports and the DMRS ports should be enhanced. In addition, the power factor related to PUSCH to PT-RS power ratio per layer per RE considering SDM and FDM based multi-panel PUSCH scheme shall be considered.

This disclosure targets the issues of PT-RS enhancement for simultaneous multi-panel UL transmission.

### BRIEF SUMMARY

Methods and apparatuses for PT-RS enhancement are disclosed.

In one embodiment, a UE comprises a transceiver; and a processor coupled to the transceiver, wherein the processor is configured to receive, via the transceiver, a configuration to transmit 2 or 4 PT-RS ports when 4 antenna ports codebook based PUSCH transmission is configured; and determine the mapping between PUSCH antenna ports and the PT-RS ports.

In some embodiment, the processor is further configured to determine, for each of the transmitted PT-RS ports, a DMRS port associated with the transmitted PT-RS port.

In some embodiment, if the configuration is to transmit PT-RS port 0 and PT-RS port 1, PUSCH antenna ports 1000, 1001, 1002 and 1003 associated with a first panel share PT-RS port 0, PUSCH antenna port 1000, 1001, 1002 and 1003 associated with a second panel share PT-RS port 1. Further, if one PUSCH layer of the PUSCH transmission is transmitted by one panel of the first panel and the second panel and two or three PUSCH players of the PUSCH transmission are transmitted by the other panel of the first panel and the second panel, the PT-RS port shared by the PUSCH antenna ports associated with the other panel is associated with one of the DMRS ports associated with the other panel according to the field value of a PT-RS-DMRS association field based on a first predefined table. In another situation, if two PUSCH layers of the PUSCH transmission are transmitted by the first panel and the other two PUSCH players of the PUSCH transmission are transmitted by the second panel, the PT-RS port shared by the PUSCH antenna ports associated with the first panel is associated with one of the DMRS ports associated with the first panel according to MSB of the field value of a PT-RS-DMRS association field based on a second predefined table, and PT-RS port shared by the PUSCH antenna ports associated with the second panel is associated with one of the DMRS ports associated with the second panel according to LSB of the field value of the PT-RS-DMRS association field based on the second predefined table.

In some embodiment, if the configuration is to transmit PT-RS port 0, PT-RS port 1, PT-RS port 2 and PT-RS port 3 when 4 antenna ports partial coherent or non-coherent codebook based PUSCH transmission is configured, PUSCH antenna ports 1000 and 1002 associated with a first panel share PT-RS port 0, PUSCH antenna ports 1001 and 1003 associated with the first panel share PT-RS port 1, PUSCH antenna ports 1000 and 1002 associated with a second panel share PT-RS port 2, and PUSCH antenna ports 1001 and 1003 associated with the second panel share PT-RS port 2. Further, if one PUSCH layer of the PUSCH transmission is transmitted by one panel of the first panel and the second panel and three PUSCH players of the PUSCH transmission are transmitted by the other panel of the first panel and the second panel, the PT-RS port shared by two PUSCH antenna ports associated with the other panel is associated with one DMRS port associated with the other panel that corresponds to the layer that is transmitted only by the two PUSCH antenna ports associated with the other panel, and the PT-RS port shared by the other two PUSCH antenna ports associated with the other panel is associated with one of two remaining DMRS ports associated with the other panel each of which is associated with a layer that is transmitted only by one of the other two PUSCH antenna ports associated with the other panel according to the field value of a PT-RS-DMRS association field based on a first predefined table.

In some embodiment, the processor is further configured to determine the frequency density and the RE mapping for the PT-RS port(s) for a panel according to the PRBs allocated for PUSCH transmission part associated with the panel.

In some embodiment, the processor is further configured to determine the PUSCH to PT-RS power ratios factor per layer per RE for a panel according to the number of PUSCH layers transmitted by the panel and the coherent capability of the panel.

In some embodiment, the processor is further configured to transmit, via the transceiver, a capability of full-coherent or a capability of partial-coherent or non-coherent. In another embodiment, a method performed at a UE comprises receiving a configuration to transmit 2 or 4 PT-RS ports when 4 antenna ports codebook based PUSCH transmission is configured; and determining the mapping between PUSCH antenna ports and the PT-RS ports.

In still another embodiment, a base unit comprises a transceiver; and a processor coupled to the transceiver, wherein the processor is configured to transmit, via the transceiver, a configuration to transmit 2 or 4 PT-RS ports when 4 antenna ports codebook based PUSCH transmission is configured; and determine the mapping between PUSCH antenna ports and the PT-RS ports.

In yet another embodiment, a method performed at a base unit comprises transmitting a configuration to transmit 2 or 4 PT-RS ports when 4 antenna ports codebook based PUSCH transmission is configured; and determining the mapping between PUSCH antenna ports and the PT-RS ports.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a scenario of single-DCI based multi-panel/TRP SDM based simultaneous PUSCH transmission;

FIG. 2 illustrates an example of PT-RS port(s) not being transmitted;

FIG. 3 illustrates another example of PT-RS port(s) not being transmitted;

FIG. 4 illustrates an example of association between PT-RS ports and DMRS ports for rank combination of {3, 1};

FIG. 5 is a schematic flow chart diagram illustrating an embodiment of a method;

FIG. 6 is a schematic flow chart diagram illustrating an embodiment of another method; and

FIG. 7 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

“Multi-TRP” means that a serving cell can have multiple (e.g. two) TRPs. “Multi-panel” means that a UE can have multiple (e.g. two) panels at least for UL transmission. In the condition that a UE equipped with two panels (e.g. panel #0 and panel #1) transmits UL signal (e.g. PUSCH transmissions) to a serving cell with two TRPs (e.g. TRP #0 and TRP #1), the UE may use one panel (e.g. panel #0) to transmit UL signal to one TRP (e.g. TRP #0) of the serving cell and use the other panel (e.g. panel #1) to transmit UL signal to another TRP (e.g. TRP #1) of the serving cell. So, one panel is associated with one TRP. For example, panel #0 is associated with TRP #0, and panel #1 is associated with TRP #1. So, multi-panel multi-TRP scenario can be described as multi-panel/TRP.

When two SRS resource sets for codebook or non-codebook are configured in a BWP of a cell to support multi-panel/TRP based UL transmission, each SRS resource set may correspond to a panel. The SRS resource set ID can be used to identify a panel. For example, the SRS resource set with lower SRS resource set ID corresponds to a first panel and the SRS resource set with larger SRS resource set ID corresponds to a second panel.

Incidentally, in the following description, ‘PUSCH transmission’ may be abbreviated as ‘PUSCH’.

“Multi-panel/TRP simultaneous UL transmission” means the UE transmit UL signals from multiple panels (e.g. two panels) to multiple TRPs (e.g. two TRPs) simultaneously.

A multi-panel/TRP (e.g. two panels and two TRPs) scenario is illustrated in FIG. 1. Two panels (e.g. panel #0 and panel #1) are equipped for the UE for simultaneous UL transmission, where each panel has the same number of antenna ports (e.g. 4 antenna ports or 2 antenna ports). Two SRS resource sets used for codebook or non-codebook are configured for the UE in a BWP of a cell. Panel #0 can be identified by SRS resource set #0, and Panel #1 can be identified by SRS resource set #1. Each of the two panels used for simultaneous UL transmission reports a same coherent capability. For single-DCI based multi-panel/TRP simultaneous PUSCH transmission, a single DCI schedules a PUSCH transmission to be transmitted by both panel #0 and panel #1.

Two UL or joint TCJ states are activated or indicated by a single TCJ codepoint for UL signal transmitted from two panels to two TRPs for one BWP of a cell if unified TCJ framework is configured. UL TCJ state is indicated when separate DL/UL TCJ framework is configured, where the Tx beam for UL transmit and the Rx beam for DL reception are separately indicated by UL TCJ state and DL TCJ state, respectively. Each UL TCJ state indicates a DL RS or an SRS resource for the UE to determine the TX spatial filter for UL transmission. Joint TCJ state is indicated when joint DL/UL TCJ framework is configured, where both Tx beam for UL transmission and Rx beam for DL reception are determined by the indicated joint TCJ state. Each joint TCJ state indicates a DL RS for the UE to determine the TX spatial filter for UL transmission, and the RX spatial filter for DL reception. For ease of discussion, in the following description, the indicated two UL or joint TCJ states are referred to as the two UL TCJ states, or more specifically, a first UL TCJ state and a second UL TCJ state.

The UE can be configured in two different modes for PUSCH multi-antenna precoding, referred as codebook (CB) based transmission and non-codebook (nCB) based transmission, respectively. When the UE is configured with codebook based PUSCH transmission, one or two SRS resource sets used for codebook can be configured in a BWP of a cell for the UE. When the UE is configured with non-codebook based PUSCH transmission, one or two SRS resource sets used for non-codebook can be configured in a BWP of a cell for the UE. To enable codebook based PUSCH transmission, the UE shall be configured to transmit one or more SRS resources used for codebook for channel measurement. Based on the measurements on the configured SRS resources, the gNB determines a suitable rank and the precoding matrix from a pre-defined codebook, which includes a set of precoding matrices with different ranks, and sends the information to the UE.

For non-codebook based PUSCH transmission, the UE is required to measure a CSI-RS to obtain the channel information based on channel reciprocity. The UE selects what it believes is a suitable uplink precoder and applies the selected precoder to a set of configured SRS resources with one SRS resource transmitted on each layer defined by the precoder. Based on the received SRS resources, the gNB decides to modify the UE-selected precoder for the scheduled PUSCH transmission.

The first UL TCI state is applied to the UL transmission from a first panel and the 10 second UL TCI state is applied to the UL transmission from a second panel. In the scenario illustrated in FIG. 1, the first UL TCI state is applied to the first and the second PUSCH layers transmitted by Panel #0, and the second UL TCI state is applied to the third PUSCH layers from Panel #1.

The panel can be identified by SRS resource sets configured to the UE. For example, if the UE reports a capability to support simultaneous multi-panel UL transmission, two SRS resource sets (e.g. a first SRS resource set and a second SRS resource set) for codebook (CB) or non-codebook (nCB) can be configured in a BWP of a cell, where the same number of SRS ports is configured for each SRS resource within each SRS resource set when full Tx Power mode is not configured.

When two SRS resource sets (e.g. a first SRS resource set and a second SRS resource set) for CB or nCB are configured to the UE, a first panel corresponds to the first SRS resource set, and a second panel corresponds to the second SRS resource set. The first UL TCI state is applied to the first SRS resource set, and the second UL TCI state is applied to the second SRS resource set. So, a first panel also corresponds to the first UL TCI state, and a second panel also corresponds to the second UL TCI state. The capability to support simultaneous multi-panel UL transmission can be reported by whether to support simultaneously transmit UL signals with different UL TCI states. If a UE reports to support simultaneously transmit UL signals with different UL TCI states, simultaneous multi-panel UL transmission is supported by the UE. If a UE reports that it does not support simultaneously transmit UL signals with different UL TCI states, simultaneous multi-panel UL transmission is not supported by the UE.

Simultaneous multi-panel/TRP PUSCH transmission can be SDM based simultaneous multi-panel/TRP PUSCH transmission (i.e. SDM based multi-panel/TRP PUSCH scheme) or FDM based simultaneous PUSCH transmission (i.e. FDM based multi-panel/TRP PUSCH scheme).

For SDM based multi-panel/TRP PUSCH scheme, a first set of PUSCH layer(s) are transmitted by a first panel (e.g. panel #0) by using the first UL TCI state, and a second set of PUSCH layer(s) are transmitted by the second panel (e.g. panel #1) by using the second UL TCI state.

For FDM based multi-panel/TRP PUSCH scheme, a first set of frequency resources (PRBs) are allocated for the PUSCH transmitted by the first panel using the first UL TCI state, and a second set of frequency resources (PRBs) are allocated for the PUSCH transmitted by the second panel using the second UL TCI state.

FIG. 1 illustrates a scenario of single-DCI based multi-panel/TRP SDM based simultaneous PUSCH transmission: a single DCI schedules a PUSCH transmission with 3 layers (i.e. 3 PUSCH layers) to be transmitted by both panel #0 and panel #1. Each PUSCH layer is transmitted by 4 antenna ports (e.g. PUSCH or SRS antenna ports) 1000, 1001, 1002, 1003 of a panel. Each antenna port is represented as PUSCH/SRS port in FIG. 1.

In the example of FIG. 1, the first PUSCH layer and the second PUSCH layer are transmitted by PUSCH antenna port 1000, 1001, 1002, 1003 of the first panel (panel #0 corresponding to SRS resource set #0) to TRP #0 by using the first indicated TCI state, and the third PUSCH layer is transmitted by PUSCH antenna port 1000, 1001, 1002, 1003 of the second panel (panel #1 corresponding to SRS resource set #1) to TRP #1 by using the second indicated TCI state.

When the PUSCH layers are transmitted from two panels of the UE, a precoding matrix is used to perform UL precoding on modulated data in codebook based PUSCH transmission for each panel. The UE shall perform UL precoding according to Equation 1 and Equation 2.

$$[ \begin{matrix}{z}_{0}^{( {P}_{0} )} ( i ) \\ ⋮ \\ {z}_{0}^{( {P}_{ρ - 1} )} ( i )\end{matrix} ] = {W}_{0} [ \begin{matrix}{y}_{0}^{( 0 )} ( i ) \\ ⋮ \\ {y}_{0}^{( {v}_{0 - 1} )} ( i )\end{matrix} ] \qquad Equation 1$$

where, the block of vector [y₀⁽⁰⁾(i) . . . y₀^{(ν}^{₀}⁻¹⁾(i)]^{T} is the modulated data that will be transmitted from the first panel (e.g. panel #0); W₀ is the precoding matrix applied to the first block of vector; and the block of vector [z₀^{(P}^{₀}⁾(i) . . . z₀^{(P}^{_{ρ-1}}⁾(i)]^{T} is the pre-coded data to be transmitted by the antenna port(s) of the first panel by applying the first UL TCI state. ν₀ indicates the number of PUSCH layers transmitted by the first panel. P₀ corresponds to PUSCH antenna port 1000 of the first panel and P_{ρ-1} corresponds to PUSCH antenna port 1000+ρ−1 of the first panel.

$$[ \begin{matrix}{z}_{1}^{( {P}_{0} )} ( i ) \\ ⋮ \\ {z}_{1}^{( {P}_{ρ - 1} )} ( i )\end{matrix} ] = {W}_{1} [ \begin{matrix}{y}_{1}^{( 0 )} ( i ) \\ ⋮ \\ {y}_{1}^{( {v}_{1 - 1} )} ( i )\end{matrix} ] \qquad Equation 2$$

where, the block of vector [y₁⁽⁰⁾(i) . . . y₁^{(ν}^{₁}⁻¹⁾(i)]^{T} is the modulated data that will be transmitted from the second panel (e.g. panel #1); W₁ is the precoding matrix applied to the second block of vector; and the block of vector [z₁^{(P}^{₀}⁾(i) . . . z₁^{(P}^{_{ρ}}⁻¹)(i)]^{T} is the pre-coded data to be transmitted by the antenna port(s) of the second panel by applying the second UL TCI state. ν₁ indicates the number of PUSCH layers transmitted by the second panel. P₀ corresponds to PUSCH antenna port 1000 of the second panel and P_{ρ-1} corresponds to PUSCH antenna port 1000+ρ−1 of the second panel.

W₀ and W₁ can be the same precoding matrix or different precoding matrices.

A single DCI schedules a multi-TRP simultaneous SDM based PUSCH transmission. Different PUSCH layers of the scheduled PUSCH transmission are transmitted by the first panel and the second panel. A rank combination {a+b} refers to the combination of the PUSCH layer(s) to be transmitted by the first panel (i.e. a) and the PUSCH layer(s) to be transmitted by the second panel (i.e. b), where a>=0, b>=0, and a+b<=maxRank (e.g. 4). For example, if the rank combination is {1+2}, it means that a PUSCH transmission with 3 layers (e.g. layer1, layer2, layer3) is scheduled, and one layer (i.e. layer1) is transmitted by the first panel and two layers (i.e. layer2 and layer3) are transmitted by the second panel.

A first embodiment relates association between PT-RS port(s) and PUSCH antenna port(s), and association between PT-RS port(s) and DMRS port(s).

As described above, a UE is equipped with two panels (e.g. a first panel (panel #0), and a second panel (panel #1)). Each of the two panels has the same number of antenna ports (i.e. PUSCH antenna ports). For example, each of the two panels may have two PUSCH antenna ports 1000 and 1001, or have four PUSCH antenna ports 1000, 1001, 1002 and 1003.

Coherent transmission is described as follows:

If a UE reports a capability of full-coherent and 4 antenna ports (i.e., PUSCH antenna port 1000, 1001, 1002 and 1003), all 4 PUSCH antenna ports including PUSCH antenna ports 1000, 1001, 1002 and 1003 of a same panel (it means ports 1000, 1001, 1002 and 1003 of panel #0 or ports 1000, 1001, 1002 and 1003 of panel #1) can be used for coherent transmission. For example, the precoding vector used for each layer can have 4 non-zero elements, e.g. W=½[1, 1, 1, −1]^{T} and W=½[1, j, 1, j]^{T} are valid precoding vectors for a PUSCH layer in full-coherent transmission with 4 antenna ports.

If a UE reports capability of partial-coherent or non-coherent with 4 antenna ports (i.e., PUSCH antenna port 1000, 1001, 1002 and 1003), PUSCH antenna ports 1000 and 1002 of a same panel can be used for coherent transmission, and PUSCH antenna ports 1001 and 1003 of a same panel can be used for coherent transmission. However, PUSCH antenna port 1000 or 1002 and PUSCH antenna port 1001 or 1003 of a same panel cannot be used for coherent transmission. It means that only two coherent antenna ports can be used for a PUSCH layer transmission. For example, W=½[1, 0, 1, 0]^{T} (2 non-zero elements for PUSCH antenna ports 1000 and 1002) and W=½[0, 1, 0, −j]^{T} (2 non-zero elements for PUSCH antenna ports 1001 and 1003) are valid precoding vectors for a PUSCH layer for partial-coherent transmission with 4 antenna ports, but W=½[1, 1, 1, −1]^{T} and W=½[1, j, 1, j]^{T} are invalid precoding vectors for a PUSCH layer for partial-coherent transmission with 4 antenna ports.

If a UE reports a capability of non-coherent with 4 antenna ports (i.e., PUSCH antenna port 1000, 1001, 1002 and 1003), all 4 PUSCH antenna ports cannot be used for coherent transmission. Only one antenna port can be used for a PUSCH layer transmission. For example, W=½[0, 0, 1, 0]^{T} (1 non-zero element for PUSCH antenna port 1002) and W=½[1, 0, 0, 0]^{T} (1 non-zero element for PUSCH antenna port 1000) are valid precoding vectors for a PUSCH layer for non-coherent transmission with 4 antenna ports, but W=½[1, 0, 1, 0]^{T}, W=½[0, 1, 0, −j]^{T}, W=½[1, 1, 1, −1]^{T} and W=½[1, j, 1, j]^{T} are invalid precoding vectors for a PUSCH layer for non-coherent transmission with 4 antenna ports.

As a whole, each panel (the first panel and the second panel) has for example 2 or 4 PUSCH antenna ports. So, in the following description, PUSCH antenna port(s) associated with the first panel, and PUSCH antenna port(s) associated with the second panel are described. A panel can be identified by the ID of the SRS resource set, or by one of the two UL TCI states. Accordingly, PUSCH antenna port(s) associated with the first panel also means PUSCH antenna port(s) associated with the first SRS resource set or PUSCH antenna port(s) associated with the first UL TCI state. Similarly, PUSCH antenna port(s) associated with the second panel also means PUSCH antenna port(s) associated with the second SRS resource set or PUSCH antenna port(s) associated with the second UL TCI state.

DMRS ports are described as follows:

Two DMRS types named DMRS type 1 and DMRS type 2 are specified in NR Release 15. Up to 8 DMRS ports, i.e., DMRS ports 0, 1, . . . , 7 are supported for DMRS type 1. DMRS ports 0, 1, 4 and 5 belong to CDM group 0 and DMRS ports 2, 3, 6 and 7 belong to CDM group 1. Up to 12 DMRS ports, i.e., DMRS ports 0, 1, . . . , 11 are supported for DMRS type 2. DMRS ports 0, 1, 6 and 7 belong to CDM group 0, DMRS ports 2, 3, 8 and 9 belong to CDM group 1, and DMRS ports 4, 5, 10 and 11 belong to CDM group 2.

The ‘antenna port(s)’ field in the scheduling DCI indicates a number of DMRS ports (selected from 8 DMRS ports when DMRS type 1 is configured or selected from 12 DMRS ports when DMRS type 2 is configured) each of which is associated with one PUSCH layer. It means that the number of indicated DMRS ports is equal to the number of PUSCH layers of the scheduled PUSCH transmission. Each PUSCH layer is associated with an indicated DMRS port. The CDM group (e.g. CDM group 0 or CDM group 1 when DMRS type 1 is configured, or CDM group 0 or CDM group 1 or CDM group 2 when DMRS type 2 is configured) containing the first indicated DMRS port is the first CDM group. If all of the indicated DMRS ports belong to the first CDM group, it means that the ‘antenna port(s)’ field in the scheduling DCI indicates one CDM group. If any of the indicated DMRS ports (other than the first indicated DMRS port) belongs to another CDM group different from the first CDM group including the first indicated DMRS port, it means that the ‘antenna port(s)’ field in the scheduling DCI indicates two CDM groups: the first CDM group and a second CDM group.

As a whole, each indicated DMRS port is associated with a PUSCH layer. The indicated DMRS port(s) associated with the PUSCH layer(s) transmitted by a first panel (i.e. the indicated DMRS port(s) in the first CDM group) can be referred to as the DMRS port(s) associated with the first panel or the DMRS port(s) associated with the first CDM group. The DMRS port(s) associated with the PUSCH layer(s) transmitted by a second panel (i.e. the indicated DMRS port(s) in the second CDM group) can be referred to as the DMRS port(s) associated with the second panel or the DMRS port(s) associated with the second CDM group. The first panel can be identified by the first UL TCI state, and the second panel can be identified by the second UL TCI state. So, the DMRS port(s) associated with the first panel also means the DMRS port(s) associated with the first UL TCI state, and the DMRS port(s) associated with the second panel also means the DMRS port(s) associated with the second UL TCI state. In addition, if the scheduling DCI includes two SRI fields (e.g. a first SRI field indicating one or more SRS resources within a first SRS resource set and a second SRI field indicating one or more SRS resources within a second SRS resource set), the DMRS port(s) associated with the first panel also means the DMRS port(s) associated with the first SRI field, and the DMRS port(s) associated with the second panel also means the DMRS port(s) associated with the second SRI field. Further, if the scheduling DCI includes two TPMI fields (e.g. a first TPMI field indicating a precoding matrix for the first panel, and a second TPMI field indicating a precoding matrix for the second panel), the DMRS port(s) associated with the first panel also means the DMRS port(s) associated with the first TPMI field, and the DMRS port(s) associated with the second panel also means the DMRS port(s) associated with the second TPMI field.

In a first sub-embodiment of the first embodiment, two PT-RS ports (e.g. PT-RS port 0 and PT-RS port 1) are configured for full-coherent or non-coherent UL transmission with SDM PUSCH with 2 antenna ports (i.e. PUSCH antenna ports 1000 and 1001).

PUSCH antenna ports 1000 and 1001 associated with the first panel share PT-RS port 0.

PUSCH antenna ports 1000 and 1001 associated with the second panel share PT-RS port 1.

If there are two PUSCH antenna ports, the rank combination can only be {1+1}. That is, the scheduled PUSCH transmission has two layers (e.g. layer1 and layer2), wherein, layer1 is transmitted by the first panel and layer2 is transmitted by the second panel. In this condition, the DMRS port associated with the first panel only includes the DMRS port associated with layer1, and the DMRS port associated with the second panel only includes the DMRS port associated with layer2.

PT-RS port 0, which is shared by the PUSCH antenna ports associated with the first panel, is associated with the DMRS port associated with the first panel (i.e. the DMRS port associated with layer1).

PT-RS port 1, which is shared by the PUSCH antenna ports associated with the second panel, is associated with the DMRS port associated with the second panel (i.e. the DMRS port associated with layer2).

In a second sub-embodiment of the first embodiment, two PT-RS ports (e.g. PT-RS port 0 and PT-RS port 1) are configured for full-coherent UL transmission with SDM PUSCH with 4 antenna ports (i.e. PUSCH antenna ports 1000, 1001, 1002 and 1003).

PUSCH antenna ports 1000, 1001, 1002 and 1003 associated with the first panel share PT-RS port 0.

PUSCH antenna ports 1000, 1001, 1002 and 1003 associated with the second panel share PT-RS port 1.

If there are four PUSCH antenna ports, the rank combination can be {1+1}, {2+2}, {1+2}, {2+1}, {1+3} and {3+1}.

For rank combination {1+1}, the scheduled PUSCH transmission has two layers (e.g. layer1 and layer2), in which layer1 is transmitted by the first panel and layer2 is transmitted by the second panel. In this condition, the DMRS port associated with the first panel only includes the DMRS port associated with layer1, and the DMRS port associated with the second panel only includes the DMRS port associated with layer2.

PT-RS port 0, which is shared by all the PUSCH antenna ports associated with the first panel, is associated with the DMRS port associated with the first panel (i.e. DMRS port associated with layer1).

PT-RS port 1, which is shared by all the PUSCH antenna ports associated with the second panel, is associated with the DMRS port associated with the second panel (i.e. DMRS port associated with layer2).

For rank combination {1+2}, the scheduled PUSCH transmission has three layers (e.g. layer1, layer2, and layer3), in which layer1 is transmitted by the first panel and layer2 and layer3 are transmitted by the second panel. In this condition, the DMRS port associated with the first panel only includes the DMRS port associated with layer1, and the DMRS ports associated with the second panel include the DMRS port associated with layer2 (i.e. the first indicated DMRS port associated with the second panel) and the DMRS port associated with layer3 (i.e. the second indicated DMRS port associated with the second panel).

PT-RS port 0, which is shared by all the PUSCH antenna ports associated with the first panel, is associated with the DMRS port associated with the first panel (i.e. DMRS port associated with layer1).

PT-RS port 1, which is shared by all the PUSCH antenna ports associated with the second panel, is associated with one of the DMRS ports associated with the second panel (i.e. one of the first indicated DMRS port associated with the second panel and the second indicated DMRS port associated with the second panel) according to the PT-RS-DMRS association field (which has two bits with possible field values of ‘00’, ‘01’, ‘10’ and ‘11’) contained in the scheduling DCI according to Table 1. That is, if the field value of the PT-RS-DMRS association field is 00, PT-RS port 1 is associated with the first indicated DMRS port associated with the second panel according to Table 1; and if the field value of the PT-RS-DMRS association field is 01, PT-RS port 1 is associated with the second indicated DMRS port associated with the second panel.

TABLE 1
PT-RS-DMRS association for rank combinations {1 + 2}, {2 +
1}, {1 + 3} and {3 + 1}

| Value | DMRS port |
|---|---|
| 00 | first indicated DMRS port associated with the first or the second |
| | panel |
| 01 | second indicated DMRS port associated with the first or the |
| | second panel |
| 10 | third indicated DMRS port associated with the first or the second |
| | panel |
| 11 | fourth indicated DMRS port associated with the first or the |
| | second panel |

For rank combination {2+1}, the scheduled PUSCH transmission has three layers (e.g. layer1, layer2, and layer3), in which layer1 and layer2 are transmitted by the first panel and layer3 is transmitted by the second panel. In this condition, the DMRS ports associated with the first panel include the DMRS port associated with layer1 (i.e. the first indicated DMRS port associated with the first panel) and the DMRS port associated with layer2 (i.e. the second indicated DMRS port associated with the first panel), and the DMRS port associated with the second panel only includes the DMRS port associated with layer3.

PT-RS port 0, which is shared by all the PUSCH antenna ports associated with the first panel, is associated with one of the DMRS ports associated with the first panel (i.e. one of the first indicated DMRS port associated with the first panel and the second indicated DMRS port associated with the first panel) according to the PT-RS-DMRS association field contained in the scheduling DCI according to Table 1. That is, if the field value of the PT-RS-DMRS association field is 00, PT-RS port 0 is associated with the first indicated DMRS port associated with the first panel according to Table 1; and if the field value of the PT-RS-DMRS association field is 01, PT-RS port 1 is associated with the second indicated DMRS port associated with the first panel according to Table 1.

PT-RS port 1, which is shared by all the PUSCH antenna ports associated with the second panel, is associated with the DMRS port associated with the second panel (i.e. the DMRS port associated with layer3).

For rank combination {2+2}, the scheduled PUSCH transmission has four layers (e.g. layer1, layer2, layer3 and layer4), wherein, layer1 and layer2 are transmitted by the first panel and layer3 and layer4 are transmitted by the second panel. In this condition, the DMRS ports associated with the first panel include the DMRS port associated with layer1 (i.e. the first indicated DMRS port associated with the first panel) and the DMRS port associated with layer2 (i.e. the second indicated DMRS port associated with the first panel), and the DMRS ports associated with the second panel include the DMRS port associated with layer3 (i.e. the first indicated DMRS port associated with the second panel) and the DMRS port associated with layer4 (i.e. the second indicated DMRS port associated with the second panel).

PT-RS port 0, which is shared by all the PUSCH antenna ports associated with the first panel, is associated with one of the DMRS ports associated with the first panel (i.e. one of the first indicated DMRS port associated with the first panel and the second indicated DMRS port associated with the first panel) according to MSB of the PT-RS-DMRS association field value contained in the scheduling DCI according to Table 2. That is, if the MSB of the field value of the PT-RS-DMRS association field is indicated as 0, PT-RS port 0 is associated with the first indicated DMRS port associated with the first panel according to Table 2; and if the MSB of the field value of the PT-RS-DMRS association field is indicated as 1, PT-RS port 0 is associated with the second indicated DMRS port associated with the first panel according to Table 2.

PT-RS port 1, which is shared by all the PUSCH antenna ports associated with the second panel, is associated with one of the DMRS ports associated with the second panel (i.e. one of the first indicated DMRS port associated with the second panel and the second indicated DMRS port associated with the second panel) according to LSB of the PT-RS-DMRS association field value contained in the scheduling DCI according to Table 2. That is, if the LSB of the field value of the PT-RS-DMRS association field is indicated as 0, PT-RS port 1 is associated with the first indicated DMRS port associated with the second panel according to Table 2; and if the LSB of the field value of the PT-RS-DMRS association field is indicated as 1, PT-RS port 1 is associated with the second indicated DMRS port associated with the second panel according to Table 2.

TABLE 2
PT-RS-DMRS association for rank combination {2 + 2}

| Value of | | Value of | |
|---|---|---|---|
| MSB | DMRS port | LSB | DMRS port |
| 0 | first indicated | 0 | first indicated |
| | DMRS port | | DMRS port |
| | associated with | | associated with |
| | the first panel | | the second panel |
| 1 | second indicated | 1 | second indicated |
| | DMRS port | | DMRS port |
| | associated with | | associated with |
| | the first panel | | the second panel |

Incidentally, Table 1 and Table 2 can be specified in a technical standard, which means that both the UE and gNB know Table 1 and Table 2. Alternatively, Table 1 and Table 2 can be sent to UE via a higher layer parameter by the gNB.

For rank combination {1+3}, the scheduled PUSCH transmission has four layers (e.g. layer1, layer2, layer3 and layer4), in which layer1 is transmitted by the first panel and layer2, layer 3 and layer4 are transmitted by the second panel. In this condition, the DMRS port associated with the first panel only includes the DMRS port associated with layer1, and the DMRS ports associated with the second panel include the DMRS port associated with layer2 (i.e. the first indicated DMRS port associated with the second panel), the DMRS port associated with layer3 (i.e. the second indicated DMRS port associated with the second panel) and the DMRS port associated with layer4 (i.e. the third indicated DMRS port associated with the second panel).

PT-RS port 0, which is shared by all the PUSCH antenna ports associated with the first panel, is associated with the DMRS port associated with the first panel (i.e. the DMRS port associated with layer1).

PT-RS port 1, which is shared by all the PUSCH antenna ports associated with the second panel, is associated with one of the DMRS ports associated with the second panel (i.e. one of the first indicated DMRS port associated with the second panel, the second indicated DMRS port associated with the second panel, and the third indicated DMRS port associated with the second panel) according to the PT-RS-DMRS association field value contained in the scheduling DCI according to Table 1. That is, if the field value of the PT-RS-DMRS association field is 00, PT-RS port 1 is associated with the first indicated DMRS port associated with the second panel according to Table 1; if the field value of the PT-RS-DMRS association field is 01, PT-RS port 1 is associated with the second indicated DMRS port associated with the second panel according to Table 1; and if the field value of the PT-RS-DMRS association field is 10, PT-RS port 1 is associated with the third indicated DMRS port associated with the second panel according to Table 1.

For rank combination {3+1}, the scheduled PUSCH transmission has four layers (e.g. layer1, layer2, layer3 and layer4), in which layer 1, layer2 and layer3 are transmitted by the first panel, and layer4 is transmitted by the second panel. In this condition, and the DMRS ports associated with the first panel include the DMRS port associated with layer1 (i.e. the first indicated DMRS port associated with the first panel), the DMRS port associated with layer2 (i.e. the second indicated DMRS port associated with the first panel) and the DMRS port associated with layer3 (i.e. the third indicated DMRS port associated with the first panel), and the DMRS port associated with the second panel only includes the DMRS port associated with layer4.

PT-RS port 0, which is shared by all the PUSCH antenna ports associated with the first panel, is associated with one of the DMRS ports associated with the first panel (i.e. one of the first indicated DMRS port associated with the first panel, the second indicated DMRS port associated with the first panel, and the third indicated DMRS port associated with the first panel) according to the PT-RS-DMRS association field value contained in the scheduling DCI according to Table 1. That is, if the field value of the PT-RS-DMRS association field is indicated as 00, PT-RS port 1 is associated with the first indicated DMRS port associated with the first panel according to Table 1; if the field value of the PT-RS-DMRS association field is indicated as 01, PT-RS port 1 is associated with the second indicated DMRS port associated with the first panel according to Table 1; and if the field value of the PT-RS-DMRS association field is indicated as 10, PT-RS port 1 is associated with the third indicated DMRS port associated with the first panel according to Table 1.

PT-RS port 1, which is shared by all the PUSCH antenna ports associated with the second panel, is associated with the DMRS port associated with the second panel (i.e. the DMRS port associated with layer4).

In a third sub-embodiment of the first embodiment, up to four PT-RS ports (e.g. two PT-RS ports or four PT-RS ports) can be configured subject to UE capability reporting for partial-coherent and non-coherent UL transmission with SDM PUSCH with 4 antenna ports (i.e. PUSCH antenna ports 1000, 1001, 1002 and 1003).

If two PT-RS ports are configured subject to UE capability reporting for partial-coherent and non-coherent UL transmission with SDM PUSCH with 4 antenna ports (i.e. PUSCH antenna ports 1000, 1001, 1002 and 1003), the same association between the two PT-RS ports and the PUSCH antenna ports and the same association between the two PT-RS ports and the DMRS ports as described in the second sub-embodiment of the first embodiment are applied.

If four PT-RS ports (e.g. PT-RS port 0, PT-RS port 1, PT-RS port 2 and PT-RS port 3) are configured for partial-coherent and non-coherent UL transmission with SDM PUSCH with 4 antenna ports (i.e. PUSCH antenna ports 1000, 1001, 1002 and 1003), the association between the four PT-RS ports and the PUSCH antenna ports and the association between the four PT-RS ports and the DMRS ports are described as follows:
PUSCH antenna ports 1000 and 1002 associated with the first panel share PT-RS port 0.
PUSCH antenna ports 1001 and 1003 associated with the first panel share PT-RS port 1.
PUSCH antenna ports 1000 and 1002 associated with the second panel share PT-RS port 2.
PUSCH antenna ports 1001 and 1003 associated with the second panel share PT-RS port 3.

If there are four PUSCH antenna ports, the rank combination can be {1+1}, {2+2}, {1+2}, {2+1}, {1+3} and {3+1}.

The association between the PT-RS ports and the DMRS ports for rank combination {1+1} is as follows.

PT-RS port 0 or PT-RS port 1, which is transmitted, is associated with the DMRS port associated with the first panel (i.e. the DMRS port associated with layer1). Which one of PT-RS port 0 and PT-RS port 1 is transmitted is dependent on the precoding matrix indicated by the TPMI field for the first panel. For example, if a precoding matrix W₀=½[1, 0, 1, 0]^{T} is indicated for the first panel, PT-RS port 0 is transmitted (since only PUSCH antenna port 1000 and PUSCH antenna port 1002 of the first panel are used for PUSCH transmission) and PT-RS port 1 is not transmitted (since PUSCH antenna port 1001 and PUSCH antenna port 1003 of the first panel are not used for PUSCH transmission).

PT-RS port 2 or PT-RS port 3, which is transmitted, is associated with the DMRS port associated with the second panel (i.e. the DMRS port associated with layer2). Which one of PT-RS port 2 and PT-RS port 3 is transmitted is dependent on the precoding matrix indicated by the TPMI field for the second panel. For example, if a precoding matrix W₁=½[0, 1, 0, 1]^{T} is indicated for the second panel, PT-RS port 3 is transmitted (since only PUSCH antenna port 1001 and PUSCH antenna port 1003 of the second panel are used for PUSCH transmission) and PT-RS port 2 is not transmitted (since PUSCH antenna port 1000 and PUSCH antenna port 1002 of the second panel are not used for PUSCH transmission).

The association between the PT-RS ports and the DMRS ports for rank combination {1+2} is as follows.

PT-RS port 0 or PT-RS port 1, which is transmitted, is associated with the indicated DMRS port associated with the first panel. Which one of PT-RS port 0 and PT-RS port 1 is transmitted is dependent on the precoding matrix W₀ indicated by the TPMI field for the first panel.

PT-RS port 2 is associated with the first indicated DMRS port associated with the second panel (i.e. the DMRS port associated with layer2).

PT-RS port 3 is associated with the second indicated DMRS port associated with the second panel (i.e. the DMRS port associated with layer3).

The association between the PT-RS ports and the DMRS ports for rank combination {2+1} is as follows.

PT-RS port 0 is associated with the first indicated DMRS port associated with the first panel (i.e. the DMRS port associated with layer1).

PT-RS port 1 is associated with the second indicated DMRS port associated with the first panel (i.e. the DMRS port associated with layer2).

PT-RS port 2 or PT-RS port 3, which is transmitted, is associated with the indicated DMRS port associated with the second panel (i.e. the DMRS port associated with layer3). Which one of PT-RS port 2 and PT-RS port 3 is transmitted is dependent on the precoding matrix W₁ indicated by the TPMI field for the second panel.

The association between the PT-RS ports and the DMRS ports for rank combination {2+2} is as follows.

PT-RS port 0 is associated with the first indicated DMRS port associated with the first panel (i.e. the DMRS port associated with layer0).

PT-RS port 1 is associated with the second indicated DMRS port associated with the first panel (i.e. the DMRS port associated with layer1).

PT-RS port 2 is associated with the first indicated DMRS port associated with the second panel (i.e. the DMRS port associated with layer2).

PT-RS port 3 is associated with the second indicated DMRS port associated with the second panel (i.e. the DMRS port associated with layer3).

The association between the PT-RS ports and the DMRS ports for rank combination {1+3} is as follows.

PT-RS port 0 or PT-RS port 1, which is transmitted, is associated with the indicated DMRS port associated with the first panel. Which one of PT-RS port 0 and PT-RS port 1 is transmitted is dependent on the precoding matrix indicated by the TPMI field for the first panel. For example, if a precoding matrix W₀=½[1, 0, 1, 0]^{T} is indicated for the first panel, PT-RS port 0 is transmitted (since only PUSCH antenna port 1000 and PUSCH antenna port 1002 of the first panel are used for PUSCH transmission) and PT-RS port 1 is not transmitted (since PUSCH antenna port 1001 and PUSCH antenna port 1003 of the first panel are not used for PUSCH transmission). If a precoding matrix W₀=½[0, 1, 0, −j]^{T} is indicated for the first panel, PT-RS port 0 is not transmitted and PT-RS port 1 is transmitted.

PT-RS port 2 and PT-RS port 3 are associated with the indicated DMRS ports associated with the second panel. Since there are three indicated DMRS ports associated with the second panel, the association of PT-RS port 2 and PT-RS port 3 and two out of the three indicated DMRS ports associated with the second panel is determined according to the precoding matrix indicated by the TPMI field for the second panel and the PT-RS-DMRS association field value according to Table 1. According to the precoding matrix, the DMRS port associated with the layer that is transmitted by the PUSCH antenna ports shared by a PT-RS port (which is either PT-RS port 2 or PT-RS port 3) is associated with the shared PT-RS port, while the other PT-RS port is associated with one of the other two indicated DRMS ports associated with the second panel according to the PT-RS-DMRS association field value according to Table 1.

The association between the PT-RS ports and the DMRS ports for rank combination {3+1} is as follows.

PT-RS port 0 and PT-RS port 1 are associated with the indicated DMRS ports associated with the first panel. Since there are three indicated DMRS ports associated with the first panel, the association of PT-RS port 0 and PT-RS port 1 and two out of the three indicated DMRS ports associated with the first panel is determined according to the precoding matrix indicated by the TPMI field for the first panel and the PT-RS-DMRS association field value according to Table 1. According to the precoding matrix, the DMRS port associated with the layer that is transmitted by the PUSCH antenna ports shared by a PT-RS port (which is either PT-RS port 0 or PT-RS port 1) is associated with the shared PT-RS port, while the other PT-RS port is associated with one of the other two indicated DRMS ports associated with the first panel according to the PT-RS-DMRS association field value according to Table 1.

PT-RS port 2 or PT-RS port 3, which is transmitted, is associated with the indicated DMRS port associated with the second panel. Which one of PT-RS port 2 and PT-RS port 3 is transmitted is dependent on the precoding matrix indicated by the TPMI field for the second panel. For example, if a precoding matrix W₁=½[1, 0, 1, 0]^{T} is indicated for the second panel, PT-RS port 2 is transmitted (since only PUSCH antenna port 1000 and PUSCH antenna port 1002 of the second panel sharing PT-RS port 2 are used for PUSCH transmission) and PT-RS port 3 is not transmitted (since PUSCH antenna port 1001 and PUSCH antenna port 1003 of the second panel sharing PT-RS port 3 are not used for PUSCH transmission). If a precoding matrix W=½[0, 1, 0, −j]^{T} is indicated for the second panel, PT-RS port 2 is not transmitted and PT-RS port 3 is transmitted.

The association between PT-RS port(s) and DMRS port(s) is described as above. It means that each transmitted PT-RS port is associated with a DMRS port. Some PT-RS port(s) may not be transmitted since some PUSCH antenna port(s) sharing the same PT-RS port(s) are not used for PUSCH transmission depending on the indicated precoding matrix. If one PT-RS port may be associated with multiple candidate DMRS ports, one DMRS port is selected from the candidate DMRS ports according to the field value of the PT-RS-DMRS association field according to Table 1 (which indicates PT-RS-DMRS association for rank combinations in which the rank of the precoding matrix for the first panel is different from the rank of the precoding matrix for the second panel) or Table 2 (which indicates PT-RS-DMRS association for rank combination in which both the rank of the precoding matrix for the first panel and the rank of the precoding matrix for the second panel are 2).

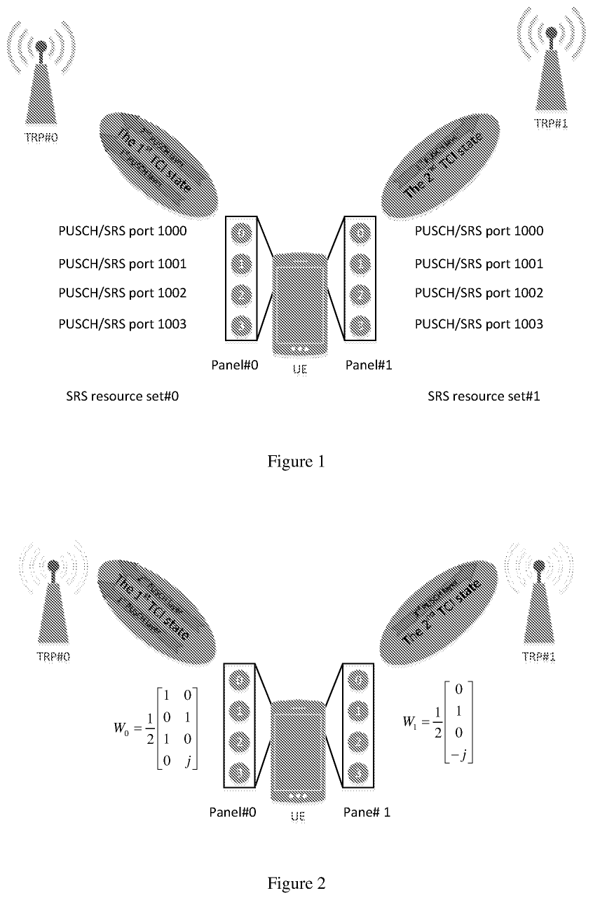

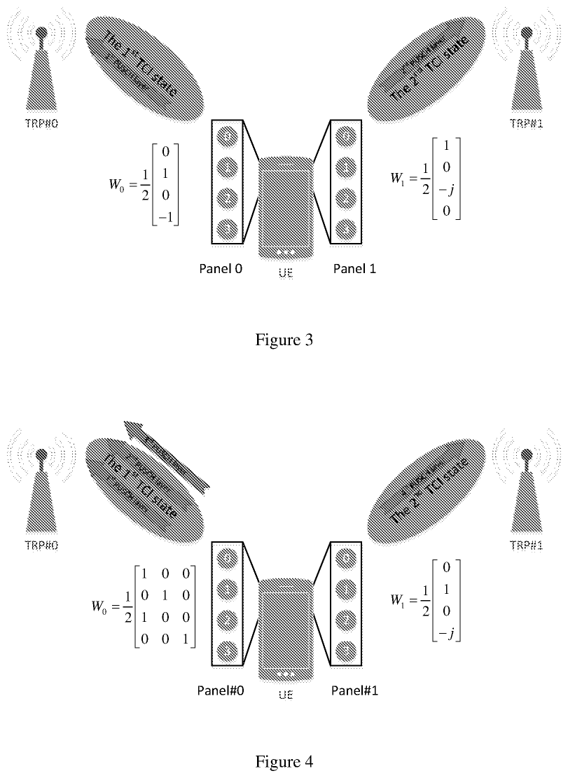

Two examples of the PT-RS port(s) not being transmitted are illustrated in FIGS. 2 and 3.

FIG. 2 illustrates a partial-coherent UL transmission with SDM PUSCH with 4 antenna ports 1000, 1001, 1002 and 1003 (denoted as \textcircled{0}, \textcircled{1}, \textcircled{2} and \textcircled{3} in FIG. 2), in which PT-RS ports 0, 1, 2 and 3 are configured. PUSCH antenna ports 1000 and 1002 associated with panel #0 (first panel) share PT-RS port 0, PUSCH antenna port 1001 and 1003 associated with panel #0 share PT-RS port 1, PUSCH antenna port 1000 and 1002 associated with panel #1 (second panel) share PT-RS port 2, PUSCH antenna port 1001 and 1003 associated with panel #1 share PT-RS port 3. A SDM PUSCH transmission with three layers (e.g. a first PUSCH layer, a second PUSCH layer and a third PUSCH layer) is scheduled. According to the precoding matrix for panel #0 (which has a rank equal to 2, indicating that the first PUSCH layer and the second PUSCH layer are transmitted by panel #0), the first PUSCH layer is transmitted over PUSCH antenna ports 1000 and 1002 associated with panel #0, and the second PUSCH layer is transmitted over PUSCH antenna ports 1001 and 1003 associated with panel #0. According to the precoding matrix for panel #1, the third PUSCH layer is transmitted over PUSCH antenna ports 1001 and 1003 associated with panel #1. Therefore, PT-RS port 0 (which is shared by PUSCH antenna ports 1000 and 1002 associated with panel #0), PT-RS port 1 (which is shared by PUSCH antenna ports 1001 and 1003 associated with panel #0) and PT-RS port 3 (which is shared by PUSCH antenna ports 1001 and 1003 associated with panel #1) are transmitted, whereas PT-RS port 2 (which is shared by PUSCH antenna ports 1000 and 1002 associated with panel #1) is not transmitted since PUSCH antenna ports 1000 and 1002 associated with panel #1 sharing PT-RS port 2 are not used for PUSCH transmission.

In the example of FIG. 3, a SDM PUSCH transmission with two layers is scheduled. According to the precoding matrix for panel #0, the first PUSCH layer is transmitted over PUSCH antenna ports 1001 and 1003 associated with panel #0. According to the precoding matrix for panel #1, the second PUSCH layer is transmitted over PUSCH antenna ports 1000 and 1002 associated with panel #1. So, only PT-RS port 1 and PT-RS port 2 are transmitted while PT-RS port 0 and PT-RS port 3 are not transmitted.

FIG. 4 illustrates an example of the association between PT-RS ports and DMRS ports for rank combination of {3, 1} according to the third sub-embodiment of the first embodiment. PT-RS port 0 shared by PUSCH antenna ports 1000 and 1002 associated with panel #0 and PT-RS port 1 shared by PUSCH antenna ports 1001 and 1003 associated with panel #0 shall be associated with two out of the three DMRS ports associated with panel #0 (e.g. the first indicated DMRS port associated with panel #0 (i.e. the indicated DMRS port associated with the first PUSCH layer), the second indicated DMRS port associated with panel #0 (i.e. the indicated DMRS port associated with the second PUSCH layer), and the third indicated DMRS port associated with panel #0 (i.e. the indicated DMRS port associated with the third PUSCH layer)). According to the precoding matrix for panel #1, the first PUSCH layer is transmitted by PUSCH antenna ports 1000 and 1002 associated with panel #0 shared by PT-RS port 0, whereas the second PUSCH layer is transmitted by PUSCH antenna port 1001 associated with panel #0, and the third PUSCH layer is transmitted by PUSCH antenna port 1003 associated with panel #0. So, PT-RS port 0 is associated with the indicated DMRS port associated with the first PUSCH layer (i.e. the first indicated DMRS port associated with panel #0) since the first PUSCH layer is transmitted by PUSCH antenna ports 1000 and 1002 associated with panel #0 shared by PT-RS port 0. PT-RS port 1 is associated with one of the remaining indicated DMRS ports associated with panel #0 (i.e. the second indicated DMRS port associated with panel #0 (i.e. the indicated DMRS port associated with the second PUSCH layer), and the third indicated DMRS port associated with panel #0 (i.e. the indicated DMRS port associated with the third PUSCH layer)) according to the PT-RS-DMRS association field value according to Table 1. If the remaining indicated DMRS ports associated with panel #0 are counted based on the number of the indicated DMRS ports associated with panel #0, they are the second indicated DMRS port associated with panel #0 (corresponding to value 1 of Table 1) and the third indicated DMRS port associated with panel #0 (corresponding to value 2 of Table 1). If the remaining indicated DMRS ports associated with panel #0 are counted based on the number of the remaining indicated DMRS ports associated with panel #0 (i.e. excluding the first DMRS port associated with panel #0 that has been associated with PT-RS 0), the second indicated DMRS port associated with panel #0 will be the first remaining indicated DMRS port associated with panel #0 (corresponding to value 0 of Table 1), and the third indicated DMRS port associated with panel #0 will be the second remaining indicated DMRS port associated with panel #0 (corresponding to value 1 of Table 1). Suppose the field value 10 of the PT-RS-DMRS association field is indicated, PT-RS port 1 is associated with the third indicated DMRS port associated with panel #0 according to Table 1. Because the fourth PUSCH layer is transmitted by antenna ports 1001 and 1003 of panel #1 sharing PT-RS port 3, PT-RS port 3, which is transmitted, is associated with the indicated DMRS port associated with panel #1 (i.e. the indicated DMRS port associated with the four PUSCH layer). PT-RS port 2 is not transmitted.

A second embodiment relates to PT-RS power boosting.

Power boosting for UL PT-RS was supported. It means that the power of the muted RE for PT-RS rate matching can be borrowed for the actual PT-RS port to ensure the power of PUSCH and PT-RS are the same. In the case that a PUSCH is transmitted by a single panel, all PUSCH resources are transmitted from a single panel with a Tx power. Power boosting is performed among all the PUSCH layers.

However, for SDM based multi-panel PUSCH transmission, a PUSCH transmission is transmitted by different panels (e.g. two panels) with different Tx powers. So, power boosting should be performed among the PUSCH layers and the associated PT-RS ports per panel (e.g. associated with each indicated UL TCI state).

A third embodiment relates to PT-RS for FDM based multi-panel PUSCH scheme.

In FDM based simultaneous multi-panel PUSCH transmission (e.g. FDM scheme A or scheme B), a first set of frequency resources (PRBs) are allocated for the PUSCH transmitted by the first panel using the first UL TCI state, and a second set of frequency resources (PRBs) are allocated for the PUSCH transmitted by the second panel using the second UL TCI state. For example, if n_{PRB} PRBs are indicated by the FDRA field contained in the scheduling DCI, the first

$$⌈ \frac{{n}_{PRB}}{2} ⌉$$

PRBs are assigned to the first panel and the first UL TCI state, and the remaining

$$⌊ \frac{{n}_{PRB}}{2} ⌋$$

PRBs are assigned to the second panel and the second UL TCI state. ┌x┐ means the smallest integer number equals to or larger than x. └x┘ means the largest integer number equals to or smaller than x.

Up to two PT-RS ports can be configured and are transmitted according to the coherent capability and the precoding matrix indicated by the TPMI field. The same PT-RS port(s) shall be transmitted with the PUSCH resource or the PUSCH transmission occasion associated with the first panel or the second panel. The DMRS port(s) are associated with each PT-RS port as indicated by the DMRS-PT-RS-association field contained in the scheduling DCI.

Due to the first

$$⌈ \frac{{n}_{PRB}}{2} ⌉$$

PRBs are assigned to the first panel and the first UL TCI state and the remaining

$$⌊ \frac{{n}_{PRB}}{2} ⌋$$

PRBs are assigned to the second panel and the second UL TCI state, the PT-RS frequency density for the PT-RS port(s) shall be determined by the number of PRBs

$$( e . g . ⌈ \frac{{n}_{PRB}}{2} ⌉ PRBs or ⌊ \frac{{n}_{PRB}}{2} ⌋ PRBs )$$

associated with each of the first UL TCI state and the second UL TCI state, instead of by the number of PRBs (e.g. n_{PRB} PRBs) allocated to the scheduled PUSCH transmission. That is, the PT-RS frequency density for the PT-RS port(s) for a first panel is determined according to the PRBs

$$( e . g . ⌈ \frac{{n}_{PRB}}{2} ⌉ PRBs )$$

allocated for PUSCH transmission part associated with the first panel, and the PT-RS frequency density for the PT-RS port(s) for a second panel is determined according to the PRBs

$$( e . g . ⌊ \frac{{n}_{PRB}}{2} ⌋ PRBs )$$

allocated for PUSCH transmission part associated with the second panel. In addition, the PT-RS resource element mapping is associated to the allocated PRBs for each UL TCI state

$$( e . g . ⌈ \frac{{n}_{PRB}}{2} ⌉ PRBs or ⌊ \frac{{n}_{PRB}}{2} ⌋ PRBs ) .$$

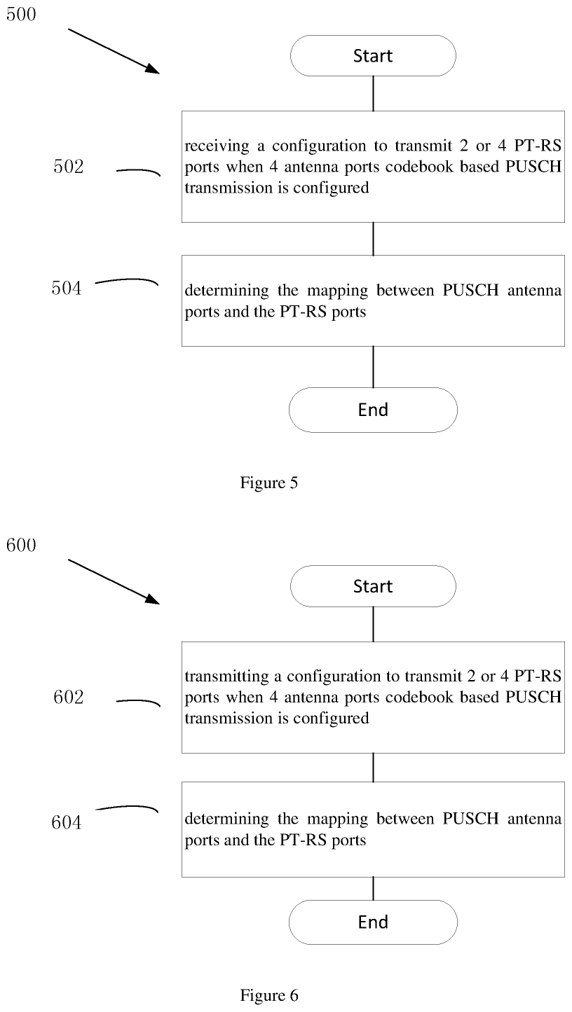

FIG. 5 is a schematic flow chart diagram illustrating an embodiment of a method 500 according to the present application. In some embodiments, the method 500 is performed by an apparatus, such as a remote unit (e.g. UE). In certain embodiments, the method 500 may be performed by a processor executing program code, for example, a microcontroller, a microprocessor, a CPU, a GPU, an auxiliary processing unit, a FPGA, or the like.

The method 500 is a method performed at a UE, comprising: 502 receiving a configuration to transmit 2 or 4 PT-RS ports when 4 antenna ports codebook based PUSCH transmission is configured; and 504 determining the mapping between PUSCH antenna ports and the PT-RS ports.

In some embodiment, the method further comprises determining, for each of the transmitted PT-RS ports, a DMRS port associated with the transmitted PT-RS port.

In some embodiment, if the configuration is to transmit PT-RS port 0 and PT-RS port 1, PUSCH antenna ports 1000, 1001, 1002 and 1003 associated with a first panel share PT-RS port 0, PUSCH antenna port 1000, 1001, 1002 and 1003 associated with a second panel share PT-RS port 1. Further, if one PUSCH layer of the PUSCH transmission is transmitted by one panel of the first panel and the second panel and two or three PUSCH players of the PUSCH transmission are transmitted by the other panel of the first panel and the second panel, the PT-RS port shared by the PUSCH antenna ports associated with the other panel is associated with one of the DMRS ports associated with the other panel according to the field value of a PT-RS-DMRS association field based on a first predefined table. In another situation, if two PUSCH layers of the PUSCH transmission are transmitted by the first panel and the other two PUSCH players of the PUSCH transmission are transmitted by the second panel, the PT-RS port shared by the PUSCH antenna ports associated with the first panel is associated with one of the DMRS ports associated with the first panel according to MSB of the field value of a PT-RS-DMRS association field based on a second predefined table, and PT-RS port shared by the PUSCH antenna ports associated with the second panel is associated with one of the DMRS ports associated with the second panel according to LSB of the field value of the PT-RS-DMRS association field based on the second predefined table.

In some embodiment, if the configuration is to transmit PT-RS port 0, PT-RS port 1, PT-RS port 2 and PT-RS port 3 when 4 antenna ports partial coherent or non-coherent codebook based PUSCH transmission is configured, PUSCH antenna ports 1000 and 1002 associated with a first panel share PT-RS port 0, PUSCH antenna ports 1001 and 1003 associated with the first panel share PT-RS port 1, PUSCH antenna ports 1000 and 1002 associated with a second panel share PT-RS port 2, and PUSCH antenna ports 1001 and 1003 associated with the second panel share PT-RS port 2. Further, if one PUSCH layer of the PUSCH transmission is transmitted by one panel of the first panel and the second panel and three PUSCH players of the PUSCH transmission are transmitted by the other panel of the first panel and the second panel, the PT-RS port shared by two PUSCH antenna ports associated with the other panel is associated with one DMRS port associated with the other panel that corresponds to the layer that is transmitted only by the two PUSCH antenna ports associated with the other panel, and the PT-RS port shared by the other two PUSCH antenna ports associated with the other panel is associated with one of two remaining DMRS ports associated with the other panel each of which is associated with a layer that is transmitted only by one of the other two PUSCH antenna ports associated with the other panel according to the field value of a PT-RS-DMRS association field based on a first predefined table.

In some embodiment, the method further comprises determining the frequency density and the RE mapping for the PT-RS port(s) for a panel according to the PRBs allocated for PUSCH transmission part associated with the panel.

In some embodiment, the method further comprises determining the PUSCH to PT-RS power ratios factor per layer per RE for a panel according to the number of PUSCH layers transmitted by the panel and the coherent capability of the panel.

In some embodiment, the method further comprises transmitting a capability of full-coherent or a capability of partial-coherent or non-coherent.

FIG. 6 is a schematic flow chart diagram illustrating an embodiment of a method 600 according to the present application. In some embodiments, the method 600 is performed by an apparatus, such as a base unit. In certain embodiments, the method 600 may be performed by a processor executing program code, for example, a microcontroller, a microprocessor, a CPU, a GPU, an auxiliary processing unit, a FPGA, or the like.

The method 600 may comprise 602 transmitting a configuration to transmit 2 or 4 PT-RS ports when 4 antenna ports codebook based PUSCH transmission is configured; and 604 determining the mapping between PUSCH antenna ports and the PT-RS ports.

In some embodiment, the method further comprises determining, for each of the transmitted PT-RS ports, a DMRS port associated with the transmitted PT-RS port.

In some embodiment, if the configuration is to transmit PT-RS port 0 and PT-RS port 1, PUSCH antenna ports 1000, 1001, 1002 and 1003 associated with a first panel share PT-RS port 0, PUSCH antenna port 1000, 1001, 1002 and 1003 associated with a second panel share PT-RS port 1. Further, if one PUSCH layer of the PUSCH transmission is transmitted by one panel of the first panel and the second panel and two or three PUSCH players of the PUSCH transmission are transmitted by the other panel of the first panel and the second panel, the PT-RS port shared by the PUSCH antenna ports associated with the other panel is associated with one of the DMRS ports associated with the other panel according to the field value of a PT-RS-DMRS association field based on a first predefined table. In another situation, if two PUSCH layers of the PUSCH transmission are transmitted by the first panel and the other two PUSCH players of the PUSCH transmission are transmitted by the second panel, the PT-RS port shared by the PUSCH antenna ports associated with the first panel is associated with one of the DMRS ports associated with the first panel according to MSB of the field value of a PT-RS-DMRS association field based on a second predefined table, and PT-RS port shared by the PUSCH antenna ports associated with the second panel is associated with one of the DMRS ports associated with the second panel according to LSB of the field value of the PT-RS-DMRS association field based on the second predefined table.

In some embodiment, if the configuration is to transmit PT-RS port 0, PT-RS port 1, PT-RS port 2 and PT-RS port 3 when 4 antenna ports partial coherent or non-coherent codebook based PUSCH transmission is configured, PUSCH antenna ports 1000 and 1002 associated with a first panel share PT-RS port 0, PUSCH antenna ports 1001 and 1003 associated with the first panel share PT-RS port 1, PUSCH antenna ports 1000 and 1002 associated with a second panel share PT-RS port 2, and PUSCH antenna ports 1001 and 1003 associated with the second panel share PT-RS port 2. Further, if one PUSCH layer of the PUSCH transmission is transmitted by one panel of the first panel and the second panel and three PUSCH players of the PUSCH transmission are transmitted by the other panel of the first panel and the second panel, the PT-RS port shared by two PUSCH antenna ports associated with the other panel is associated with one DMRS port associated with the other panel that corresponds to the layer that is transmitted only by the two PUSCH antenna ports associated with the other panel, and the PT-RS port shared by the other two PUSCH antenna ports associated with the other panel is associated with one of two remaining DMRS ports associated with the other panel each of which is associated with a layer that is transmitted only by one of the other two PUSCH antenna ports associated with the other panel according to the field value of a PT-RS-DMRS association field based on a first predefined table.

In some embodiment, the method further comprises determining the frequency density and the RE mapping for the PT-RS port(s) for a panel according to the PRBs allocated for PUSCH transmission part associated with the panel.

In some embodiment, the method further comprises determining the PUSCH to PT-RS power ratios factor per layer per RE for a panel according to the number of PUSCH layers transmitted by the panel and the coherent capability of the panel.

In some embodiment, the method further comprises receiving a capability of full-coherent or a capability of partial-coherent or non-coherent.

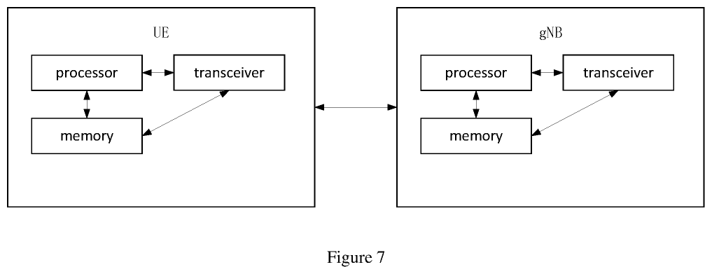

FIG. 7 is a schematic block diagram illustrating apparatuses according to one embodiment.

Referring to FIG. 7, the UE (i.e. the remote unit) includes a processor, a memory, and a transceiver. The processor implements a function, a process, and/or a method which are proposed in FIG. 5.

The UE comprises a transceiver; and a processor coupled to the transceiver, wherein the processor is configured to receive, via the transceiver, a configuration to transmit 2 or 4 PT-RS ports when 4 antenna ports codebook based PUSCH transmission is configured; and determine the mapping between PUSCH antenna ports and the PT-RS ports.

In some embodiment, the processor is further configured to determine, for each of the transmitted PT-RS ports, a DMRS port associated with the transmitted PT-RS port.

In some embodiment, if the configuration is to transmit PT-RS port 0 and PT-RS port 1, PUSCH antenna ports 1000, 1001, 1002 and 1003 associated with a first panel share PT-RS port 0, PUSCH antenna port 1000, 1001, 1002 and 1003 associated with a second panel share PT-RS port 1. Further, if one PUSCH layer of the PUSCH transmission is transmitted by one panel of the first panel and the second panel and two or three PUSCH players of the PUSCH transmission are transmitted by the other panel of the first panel and the second panel, the PT-RS port shared by the PUSCH antenna ports associated with the other panel is associated with one of the DMRS ports associated with the other panel according to the field value of a PT-RS-DMRS association field based on a first predefined table. In another situation, if two PUSCH layers of the PUSCH transmission are transmitted by the first panel and the other two PUSCH players of the PUSCH transmission are transmitted by the second panel, the PT-RS port shared by the PUSCH antenna ports associated with the first panel is associated with one of the DMRS ports associated with the first panel according to MSB of the field value of a PT-RS-DMRS association field based on a second predefined table, and PT-RS port shared by the PUSCH antenna ports associated with the second panel is associated with one of the DMRS ports associated with the second panel according to LSB of the field value of the PT-RS-DMRS association field based on the second predefined table.

In some embodiment, if the configuration is to transmit PT-RS port 0, PT-RS port 1, PT-RS port 2 and PT-RS port 3 when 4 antenna ports partial coherent or non-coherent codebook based PUSCH transmission is configured, PUSCH antenna ports 1000 and 1002 associated with a first panel share PT-RS port 0, PUSCH antenna ports 1001 and 1003 associated with the first panel share PT-RS port 1, PUSCH antenna ports 1000 and 1002 associated with a second panel share PT-RS port 2, and PUSCH antenna ports 1001 and 1003 associated with the second panel share PT-RS port 2. Further, if one PUSCH layer of the PUSCH transmission is transmitted by one panel of the first panel and the second panel and three PUSCH players of the PUSCH transmission are transmitted by the other panel of the first panel and the second panel, the PT-RS port shared by two PUSCH antenna ports associated with the other panel is associated with one DMRS port associated with the other panel that corresponds to the layer that is transmitted only by the two PUSCH antenna ports associated with the other panel, and the PT-RS port shared by the other two PUSCH antenna ports associated with the other panel is associated with one of two remaining DMRS ports associated with the other panel each of which is associated with a layer that is transmitted only by one of the other two PUSCH antenna ports associated with the other panel according to the field value of a PT-RS-DMRS association field based on a first predefined table.

In some embodiment, the processor is further configured to determine the frequency density and the RE mapping for the PT-RS port(s) for a panel according to the PRBs allocated for PUSCH transmission part associated with the panel.

In some embodiment, the processor is further configured to determine the PUSCH to PT-RS power ratios factor per layer per RE for a panel according to the number of PUSCH layers transmitted by the panel and the coherent capability of the panel.

In some embodiment, the processor is further configured to transmit, via the transceiver, a capability of full-coherent or a capability of partial-coherent or non-coherent.

The gNB (i.e. the base unit) includes a processor, a memory, and a transceiver. The processor implements a function, a process, and/or a method which are proposed in FIG. 6.

The base unit comprises a transceiver; and a processor coupled to the transceiver, wherein the processor is configured to transmit, via the transceiver, a configuration to transmit 2 or 4 PT-RS ports when 4 antenna ports codebook based PUSCH transmission is configured; and determine the mapping between PUSCH antenna ports and the PT-RS ports.

In some embodiment, the processor is further configured to determine, for each of the transmitted PT-RS ports, a DMRS port associated with the transmitted PT-RS port.

In some embodiment, if the configuration is to transmit PT-RS port 0 and PT-RS port 1, PUSCH antenna ports 1000, 1001, 1002 and 1003 associated with a first panel share PT-RS port 0, PUSCH antenna port 1000, 1001, 1002 and 1003 associated with a second panel share PT-RS port 1. Further, if one PUSCH layer of the PUSCH transmission is transmitted by one panel of the first panel and the second panel and two or three PUSCH players of the PUSCH transmission are transmitted by the other panel of the first panel and the second panel, the PT-RS port shared by the PUSCH antenna ports associated with the other panel is associated with one of the DMRS ports associated with the other panel according to the field value of a PT-RS-DMRS association field based on a first predefined table. In another situation, if two PUSCH layers of the PUSCH transmission are transmitted by the first panel and the other two PUSCH players of the PUSCH transmission are transmitted by the second panel, the PT-RS port shared by the PUSCH antenna ports associated with the first panel is associated with one of the DMRS ports associated with the first panel according to MSB of the field value of a PT-RS-DMRS association field based on a second predefined table, and PT-RS port shared by the PUSCH antenna ports associated with the second panel is associated with one of the DMRS ports associated with the second panel according to LSB of the field value of the PT-RS-DMRS association field based on the second predefined table.

In some embodiment, if the configuration is to transmit PT-RS port 0, PT-RS port 1, PT-RS port 2 and PT-RS port 3 when 4 antenna ports partial coherent or non-coherent codebook based PUSCH transmission is configured, PUSCH antenna ports 1000 and 1002 associated with a first panel share PT-RS port 0, PUSCH antenna ports 1001 and 1003 associated with the first panel share PT-RS port 1, PUSCH antenna ports 1000 and 1002 associated with a second panel share PT-RS port 2, and PUSCH antenna ports 1001 and 1003 associated with the second panel share PT-RS port 2. Further, if one PUSCH layer of the PUSCH transmission is transmitted by one panel of the first panel and the second panel and three PUSCH players of the PUSCH transmission are transmitted by the other panel of the first panel and the second panel, the PT-RS port shared by two PUSCH antenna ports associated with the other panel is associated with one DMRS port associated with the other panel that corresponds to the layer that is transmitted only by the two PUSCH antenna ports associated with the other panel, and the PT-RS port shared by the other two PUSCH antenna ports associated with the other panel is associated with one of two remaining DMRS ports associated with the other panel each of which is associated with a layer that is transmitted only by one of the other two PUSCH antenna ports associated with the other panel according to the field value of a PT-RS-DMRS association field based on a first predefined table.

In some embodiment, the processor is further configured to determine the frequency density and the RE mapping for the PT-RS port(s) for a panel according to the PRBs allocated for PUSCH transmission part associated with the panel.

In some embodiment, the processor is further configured to determine the PUSCH to PT-RS power ratios factor per layer per RE for a panel according to the number of PUSCH layers transmitted by the panel and the coherent capability of the panel.

In some embodiment, the processor is further configured to receive, via the transceiver, a capability of full-coherent or a capability of partial-coherent or non-coherent.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a configuration to transmit 2 or 4 PT-RS ports when 4 antenna ports codebook based PUSCH transmission is configured; and
determine a mapping between PUSCH antenna ports and the PT-RS ports.

2. The UE of claim 1, wherein, the at least one processor is configured to cause the UE to:
determine, for each of the transmitted PT-RS ports, a DMRS port associated with the transmitted PT-RS port.

3. The UE of claim 1, wherein;
if the configuration is to transmit PT-RS port 0 and PT-RS port 1, PUSCH antenna ports 1000, 1001, 1002 and 1003 associated with a first panel share PT-RS port 0, PUSCH antenna port 1000, 1001, 1002 and 1003 associated with a second panel share PT-RS port 1.

4. The UE of claim 1, wherein;
if the configuration is to transmit PT-RS port 0, PT-RS port 1, PT-RS port 2 and PT-RS port 3 when 4 antenna ports partial coherent or non-coherent codebook based PUSCH transmission is configured, PUSCH antenna ports 1000 and 1002 associated with a first panel share PT-RS port 0, PUSCH antenna ports 1001 and 1003 associated with the first panel share PT-RS port 1, PUSCH antenna ports 1000 and 1002 associated with a second panel share PT-RS port 2, and PUSCH antenna ports 1001 and 1003 associated with the second panel share PT-RS port 2.

5. The UE of claim 3, wherein;
if one PUSCH layer of the PUSCH transmission is transmitted by one panel of the first panel and the second panel and two or three PUSCH players of the PUSCH transmission are transmitted by the other panel of the first panel and the second panel, the PT-RS port shared by the PUSCH antenna ports associated with the other panel is associated with one DMRS port associated with the other panel according to a field value of a PT-RS-DMRS association field based on a first predefined table.

6. The UE of claim 4, wherein;
if one PUSCH layer of the PUSCH transmission is transmitted by one panel of the first panel and the second panel and three PUSCH players of the PUSCH transmission are transmitted by the other panel of the first panel and the second panel, the PT-RS port shared by two PUSCH antenna ports associated with the other panel is associated with one DMRS port associated with the other panel that corresponds to the layer that is transmitted only by the two PUSCH antenna ports associated with the other panel, and the PT-RS port shared by the other two PUSCH antenna ports associated with the other panel is associated with one of two remaining DMRS ports associated with the other panel each of which is associated with a layer that is transmitted only by one of the other two PUSCH antenna ports associated with the other panel according to a field value of a PT-RS-DMRS association field based on a first predefined table.

7. The UE of claim 3, wherein;
if two PUSCH layers of the PUSCH transmission are transmitted by the first panel and the other two PUSCH players of the PUSCH transmission are transmitted by the second panel, the PT-RS port shared by the PUSCH antenna ports associated with the first panel is associated with one DMRS port associated with the first panel according to MSB of a field value of a PT-RS-DMRS association field based on a second predefined table, and PT-RS port shared by the PUSCH antenna ports associated with the second panel is associated with the one DMRS port associated with the second panel according to LSB of the field value of the PT-RS-DMRS association field based on the second predefined table.

8. The UE of claim 1, wherein the at least one processor is configured to cause the UE to:
determine a frequency density and the RE mapping for the PT-RS port(s) for a panel according to PRBs allocated for PUSCH transmission part associated with the panel.

9. The UE of claim 1, wherein the at least one processor is configured to cause the UE to:
determine the PUSCH to PT-RS power ratios factor per layer per RE for a panel according to a number of PUSCH layers transmitted by the panel and a coherent capability of the panel.

10. The UE of claim 1, wherein the at least one processor is configured to cause the UE to:
transmit a capability of full-coherent or a capability of partial-coherent or non-coherent.

11. A method performed by a user equipment (UE), the method comprising:
receiving a configuration to transmit 2 or 4 PT-RS ports when 4 antenna ports codebook based PUSCH transmission is configured; and
determining a mapping between PUSCH antenna ports and the PT-RS ports.

12. A base station, comprising:
at least one memory; and
at least one processor coupled with the at least one memory and configured to cause the base station to:
transmit a configuration to transmit 2 or 4 PT-RS ports when 4 antenna ports codebook based PUSCH transmission is configured; and
determine a mapping between PUSCH antenna ports and the PT-RS ports.

13. A processor for wireless communication, comprising:
at least one controller coupled with at least one memory and configured to cause the processor to:
receive a configuration to transmit 2 or 4 PT-RS ports when 4 antenna ports codebook based PUSCH transmission is configured; and
determine a mapping between PUSCH antenna ports and the PT-RS ports.

14. The processor of claim 13, wherein the at least one controller is configured to cause the processor to:
determine, for each of the transmitted PT-RS ports, a DMRS port associated with the transmitted PT-RS port.

15. The processor of claim 13, wherein:
if the configuration is to transmit PT-RS port 0 and PT-RS port 1, PUSCH antenna ports 1000, 1001, 1002 and 1003 associated with a first panel share PT-RS port 0, PUSCH antenna port 1000, 1001, 1002 and 1003 associated with a second panel share PT-RS port 1.

16. The processor of claim 13, wherein:
if the configuration is to transmit PT-RS port 0, PT-RS port 1, PT-RS port 2 and PT-RS port 3 when 4 antenna ports partial coherent or non-coherent codebook based PUSCH transmission is configured, PUSCH antenna ports 1000 and 1002 associated with a first panel share PT-RS port 0, PUSCH antenna ports 1001 and 1003 associated with the first panel share PT-RS port 1, PUSCH antenna ports 1000 and 1002 associated with a second panel share PT-RS port 2, and PUSCH antenna ports 1001 and 1003 associated with the second panel share PT-RS port 2.

17. The processor of claim 15, wherein:
if one PUSCH layer of the PUSCH transmission is transmitted by one panel of the first panel and the second panel and two or three PUSCH players of the PUSCH transmission are transmitted by the other panel of the first panel and the second panel, the PT-RS port shared by the PUSCH antenna ports associated with the other panel is associated with one DMRS port associated with the other panel according to a field value of a PT-RS-DMRS association field based on a first predefined table.

18. The processor of claim 16, wherein:
if one PUSCH layer of the PUSCH transmission is transmitted by one panel of the first panel and the second panel and three PUSCH players of the PUSCH transmission are transmitted by the other panel of the first panel and the second panel, the PT-RS port shared by two PUSCH antenna ports associated with the other panel is associated with one DMRS port associated with the other panel that corresponds to the layer that is transmitted only by the two PUSCH antenna ports associated with the other panel, and the PT-RS port shared by the other two PUSCH antenna ports associated with the other panel is associated with one of two remaining DMRS ports associated with the other panel each of which is associated with a layer that is transmitted only by one of the other two PUSCH antenna ports associated with the other panel according to a field value of a PT-RS-DMRS association field based on a first predefined table.

19. The processor of claim 15, wherein:
if two PUSCH layers of the PUSCH transmission are transmitted by the first panel and the other two PUSCH players of the PUSCH transmission are transmitted by the second panel, the PT-RS port shared by the PUSCH antenna ports associated with the first panel is associated with one DMRS port associated with the first panel according to MSB of a field value of a PT-RS-DMRS association field based on a second predefined table, and PT-RS port shared by the PUSCH antenna ports associated with the second panel is associated with the one DMRS port associated with the second panel according to LSB of the field value of the PT-RS-DMRS association field based on the second predefined table.

20. The processor of claim 13, wherein the at least one controller is configured to cause the processor to:
determine a frequency density and the RE mapping for the PT-RS port(s) for a panel according to PRBs allocated for PUSCH transmission part associated with the panel.
